(19) United States
(12) Patent Application Publication
(10) Pub. No.: US 2016/0243795 A1
(43) Pub. Date: Aug. 25, 2016

(54) Profiled Molded Part from a Fibrous Composite Material and Method for Producing such a Profiled Molded Part

(71) Applicant: Holger GLÄSNER, Tecklenburg (DE)

(72) Inventor: Holger Gläsner, Tecklenburg (DE)

(21) Appl. No.: 14/911,742

(22) PCT Filed: Aug. 7, 2014
(86) PCT No.: PCT/EP2014/002171

§ 371 Date: Feb. 12, 2016

(30) Foreign Application Priority Data
Aug. 13, 2013 (DE) 10 2013 013 373.4

(51) Int. Cl. B32B 17/06; B32B 37/14; C03B 23/037; B32B 37/12; B32B 7/12; B32B 3/26

(52) U.S. Cl. CPC B32B 17/064; B32B 7/12; B32B 3/263; C03B 23/037; B32B 37/12; B32B 37/14; B32B 2250/02; B32B 2307/536

(57) ABSTRACT

The invention relates to a profiled molded part made of a fibrous composite material reinforced by continuous, long fibered or short-fibered fibers, wherein the profiled molded part is provided, at least in some regions, with a covering layer made of a thin-film glass material forming an outer surface.

The invention concerns a profiled molded part of a fibrous composite material that is reinforced by endless, long or short fibers. Moreover, the invention concerns a method for producing such a profiled molded part.

Profiled molded parts of a fibrous composite material are known. In this context, the profiled molded parts can have a flat surface but also uneven geometries. They can be embodied as glass fiber reinforced plastic (GFRP) profiled parts or carbon fiber reinforced plastic (CFRP) profiled parts. Important advantages of such fiber reinforced composite plastic components are their reduced weight and their multiple times improved mechanical properties in comparison to conventional metallic profiled shaped parts. However, fibrous composite plastic profiled molded parts can be produced to have high surface qualities only with difficulty and with high expenditure. The reasons for this are inter alia the shrinkages, the fiber proportion, the pore contents, the surface hardness, the tool quality, the matrix and fiber material qualities of the individual components. Moreover, surfaces of conventional fibrous composite plastic components are not sufficiently resistant against mechanical, thermal, and chemical loads. Often they also have wavy surfaces due to the different shrinkage behavior and/or due to pores and/or due to air inclusions. Moreover, damages on fibrous composite profiled components such as fiber breakage are frequently not visually recognizable and can be identified only with high expenditure. Components therefore can have invisible damage and can thus fail in practical use. Moreover, loads and component stress in fibrous composite parts can be measured or detected only with great expenditure but with only minimal reliability.

DE 10 2008 001 468 discloses a method for coating a fibrous composite material. This method includes a support-based pretreatment of the fibers introduced into the fibrous composite component for protection of a spaced apart surface layer of the fibrous composite component for the purpose of forming an adhesive layer, whereupon application of at least one functional layer onto the formed adhesive layer is performed. In this context, first the adhesive layer is formed and on the thus formed adhesive layer the functional layer is generated wherein the functional layer is applied by means of a thermal spraying method. The functional layer, which may also be comprised of a first and a second functional layer, wherein the second functional layer forms the outer surface of the profiled molded part, can be, for example, a corrosion layer or an insulation layer wherein the first functional layer which is positioned underneath is meant to be a metallic layer. It is preferred in this context that the second layer which forms the outer surface is also a metal layer. Such metal layers are however difficult to provide. Moreover, they significantly influence the weight of a fibrous composite profiled body and also do not have the mechanical properties demanded of fibrous composite plastic profiled molded parts. Also, the surface qualities of such metal-coated profiled molded parts are unsatisfactory.

It is the object of the present invention to provide a profiled molded part of a fibrous composite material, in particular a fibrous composite plastic material with reinforcement fibers of endless, long or short fibers, that exhibits high surface qualities.

As a solution to this object, the profiled molded part of the aforementioned kind is characterized in that the profiled molded part at least over sections thereof is provided with a cover layer that forms an outer surface and is comprised of a thin film glass material.

In this way, a profiled molded part is provided that at least over sections thereof, often however completely, is provided with a surface that is comprised of a thin film glass material due to the cover layer. In this way, profiled molded parts can be produced which, in comparison to materials formed with metallic components, is significantly lighter and exhibits better mechanical properties that however also have high surface qualities. Also, the surface of the thin film glass material is sufficiently resistant against mechanical, thermal, and chemical loads and do not exhibit the disadvantage of wavy surfaces as a result of different shrinkage behavior or as a result of pores caused by air inclusions. Accordingly, even profiled bodies with uneven and/or non-uniform geometries can be produced with glass films or thin glass materials. In general, this can be realized by a joining process or by introducing an adhesive layer or a resin. Moreover, the shaping process can be performed also in a separate process and by local tempering of the glass film, for example, in one and the same tool. However, the cover layer can also be produced separately and can then be provided subsequently with the profiled molded part.

Moreover, with a profiled molded part according to the invention it is possible to refine in general profiled molded parts with regard to their surface cover layer for improving the chemical resistance based on non-existing corrodibility, the hydrolytic resistance and with respect to acid and base resistance. Also, the mechanical resistance is improved by the thin film glass thick layer so that also a greater resistance in regard to abrasion, friction, wear, scratches, temperatures and radiations results. Also, the roughness is significantly improved. Manufacturing tolerances and processing traces on the surface of the profiled molded part can be compensated by the cover layer. The cover layer can be also used as a support layer for materials such as graphite particles, oxide ceramics and the like in order to further improve the surface properties. The cover layer can also be used as support layer for particles in order to realize a targeted surface structure but also as a carrier for graphs. A glass film can be printed on, for example, on the back side and can be provided with sensors and other devices. Also, it is possible to enable for such a component a damage identification or damage detection by visualization of damages (breakage, crack formation, and the like) by means of, for example, rearward application of coloring means in that the profiled molded part is designed, for example, as a bleeding component. The cover layer can also be designed as a sacrificial layer in order to be able to exchange it in case of a mechanical destruction. Also, such thin film glass cover layers can be cleaned better, for example, in case of being stained with graffiti. Also, they can serve as a tolerance compensation and corrosion layer.

Cover layers of glass film or thin glass can be provided in case of fibrous composite plastic materials fibrous composite sandwich components. In this context, a film or glass thickness range of approximately 0.001 to 1.1 mm, in particular in the range of 0.001 to 0.2 mm is preferred. With regard to processing, the cover layer can be generated by inserting a glass film or thin glass for one-sided or two-sided molding method into a tool or into a mold prior to an infusion, injection or curing process. Moreover, back injection molding, a resin infusion and curing directly with the glass film can be realized in the tool of the profiled molded part. In this way, a connection by melting and bonding with the profiled molded part of the fibrous composite of the plastic material can be realized. It is also possible to produce a pre-manufactured glass film or thin glass cover layer and to connect it in with a flat or three-dimensional geometry of a profiled molded part, for example, by gluing. Moreover, inserting or attaching is possible in a continuous manufacturing process. By placing underneath and/or placing on top prior to or after a manufacturing process, the glass cover layer can be provided also, for example, in case of a tape, layer or filament winding process. Also, it is possible to apply the cover layer onto a semi-finished product (plates, profiled parts, organic sheet, and the like) by lamination or pressing and optionally further subsequent deformation processes or with subsequent processing. Also, further methods are possible, for example, hand lay-up method, injection molding method, RTM method, pre-preg autoclave method, filament winding method, automated tape layer method, press-molding method, fiber spray lay-up method, RFI method, S-RIN method, MVI method, DP-RTM method, HP-RTM method, VARI method, SCRIMP method, RTM method, press-RTM method, deep drawing method, wet pressing method, hot pressing method, cold pressing method, SMC method, pultusion method, lamination method, cladding method, and the like.

The glass cover layer can be provided on the back side with printed images and sensors. Likewise, the glass cover layer can be applied as a vibration membrane for structure and result monitoring and can be provided with sensors. Moreover, cover layers can be applied sections to be detachable in sections thereof so that they serve as a sacrificial layer and serve for visualizing damages.

Further advantages embodiments can be taken from the dependent claims, reference being had expressly to them.

What is claimed is:

1.-42. (canceled)

43. A profiled molded part comprising:
a fibrous composite plastic material part of a fibrous composite material reinforced by reinforcement fibers that are endless fibers, long fibers, or short fibers;
a cover layer applied at least over sections of the fibrous composite plastic material part and forming an outer surface of the profiled molded part;
wherein the cover layer is comprised of a thin film glass material and comprises a layer thickness of 0.001 mm to 1.1 mm;
wherein the cover layer comprises 50 to 100% by weight silicon dioxide (SiO₂).

44. The profiled molded part according to claim 43, wherein the thin film glass material of the cover layer is elastic with respect to elongation and bending.

45. The profiled molded part according to claim 43, wherein the cover layer comprises 0.01 to 18% by weight aluminum oxide (Al₂O₃) based on a total composition of 100% by weight of the cover layer.

46. The profiled molded part according to claim 43, wherein the cover layer comprises 0.01 to 22% by weight sodium oxide (Na₂O) based on a total composition of 100% by weight of the cover layer.

47. The profiled molded part according to claim 43, wherein the cover layer comprises 0.01 to 19% by weight potassium oxide (K₂O) based on a total composition of 100% by weight of the cover layer.

48. The profiled molded part according to claim 43, wherein the cover layer comprises 0.01 to 8% by weight magnesium oxide (MgO) based on a total composition of 100% by weight of the cover layer.

49. The profiled molded part according to claim 43, wherein the cover layer comprises 0.01 to 22% by weight calcium oxide (CaO) based on a total composition of 100% by weight of the cover layer.

50. The profiled molded part according to claim 43, wherein the cover layer comprises 0.01 to 20% by weight boron trioxide (B₂O₃) based on a total composition of 100% by weight of the cover layer.

51. The profiled molded part according to claim 43, wherein the cover layer comprises 0.01 to 28% by weight lead oxide (PbO) based on a total composition of 100% by weight of the cover layer.

52. The profiled molded part according to claim 43, wherein the cover layer comprises 0.01 to 2% by weight titanium dioxide (TiO₂) based on a total composition of 100% by weight of the cover layer.

53. The profiled molded part according to claim 43, wherein the cover layer comprises 0.01 to 2% by weight sulfur trioxide (SO₃) based on a total composition of 100% by weight of the cover layer.

54. The profiled molded part according to claim 43, wherein the cover layer comprises additives of calcium carbonate, soda, aluminum dioxide, phosphorus pentoxide, boron trioxide, halide ion, sulfur, nitrogen and/or alkali oxides in a total composition of 100% by weight of the cover layer.

55. The profiled molded part according to claim 43, comprising a natural wood material.

56. The profile molded part according to claim 43, wherein a surface of the profiled molded part as a whole is formed by the cover layer of the thin film glass material.

57. The profiled molded part according to claim 43, further comprising an intermediate layer connecting the cover layer to fibrous composite plastic material part.

58. The profiled molded part according to claim 57, wherein the intermediate layer is comprised of an adhesive material.

59. The profiled molded part according to claim 43, wherein the cover layer is configured as sacrificial layer for identification and detection of damages of the profiled molded part.

60. The profiled molded part according to claim 43, wherein the cover layer has a density of 2 kg/dm³ to 2.8 kg/dm³.

61. The profiled molded part according to claim 43, wherein the cover layer has a tensile strength of 0.02 GPa to 5 GPa.

62. The profiled molded part according to claim 43, wherein the cover layer has a modulus of elasticity of 65 MPa to 92 MPa.

63. The profiled molded part according to claim 43, wherein the cover layer has a torsion module of 25 KN/mm² to 36 KN/mm².

64. The profiled molded part according to claim 43, wherein the cover layer has a Poisson ratio of 0.18 to 0.28.

65. The profiled molded part according to claim 43, wherein the cover layer has a thermal expansion coefficient of 2.5×10⁻⁶ 1/K to 9×10⁻⁶ 1/K.

66. The profiled molded part according to claim 43, wherein the cover layer has a Vickers hardness of 300 to 1,200.

67. The profiled molded part according to claim 43, wherein the cover layer has a transmission rate of 80% to 98%.

68. The profiled molded part according to claim 43, wherein the cover layer has a roughness of <250 nm.

69. The profiled molded part according to claim 43, wherein the cover layer has a working temperature of −65° C. to +700° C.

70. The profiled molded part according to claim 43, wherein the cover layer is hot-formable at temperatures of 500° C. to 1,000° C. and is fusible at temperatures of 700° C. to 1,400° C.

71. The profiled molded part according to claim 43, wherein the cover layer has a transformation temperature of 500° C. to 800° C.

72. The profiled molded part according to claim 43, wherein the cover layer has a melting temperature of 1,000° C. to 1,500° C.

73. The profiled molded part according to claim 43, wherein the cover layer has a thermal conductivity of 0.8 W/(m K) to 1.5 W/(m K) (watts per meter kelvin).

74. The profiled molded part according to claim 43, wherein the wavelength of the cover layer is 400 nm to 700 nm.

75. The profiled molded part according to claim 43, wherein the cover layer has a refractive index of 1.5 to 1.56.

76. The profiled molded part according to claim 43, wherein the cover layer has a Knoop hardness HK₁₀₀ of 550 to 590.

77. The profiled molded part according to claim 43, wherein the reinforcement fibers having a fiber length of 5 mm to endless are used with a matrix of a plastic material and fibers of a plastic material and/or fibers of glass, carbon, aramid, silicon carbide or basalt.

78. The profiled molded part according to claim 43, further comprising an intermediate layer of a resin, an adhesive, a matrix material of the profiled molded part, a gel, a liquid, color cells, color capillaries, silicates and/or graphites, the intermediate layer provided between the cover layer and the fibrous composite plastic material part.

79. The profiled molded part according to claim 43, wherein the cover layer comprises a back side facing the fibrous composite plastic material part, wherein the back side is provided with printed images and/or sensors and/or vibration membranes and/or actuators.

80. A method for producing a profiled molded part according to claim 43, the method comprising the steps of producing the cover layer of the thin film glass material in a separate manufacturing process by thermoforming and securing the fibrous composite plastic material part to the separately produced cover layer by gluing.

81. The method according to claim 80, wherein the cover layer is introduced into a tool and subsequently backfilled by the fibrous composite plastic material part.
